(19) United States
(12) Patent Application Publication
(10) Pub. No.: US 2018/0101244 A1
(43) Pub. Date: Apr. 12, 2018

(54) Virtual Reality Input System and Methods

(71) Applicant: VMUV LLC, Atascadero, CA (US)

(72) Inventors: Trevor Orrick, Los Osos, CA (US); Warren Woolsey, San Luis Obispo, CA (US); Erik Gutterud, Grover Beach, CA (US)

(21) Appl. No.: 15/728,820

(22) Filed: Oct. 10, 2017

Related U.S. Application Data
(60) Provisional application No. 62/406,457, filed on Oct. 11, 2016.

(51) Int. Cl. G06F 3/033; A63F 13/211; A63F 13/215; A63F 13/235; A63F 13/25; A63F 13/213; G06F 3/01

(52) U.S. Cl. CPC G06F 3/0334; A63F 13/211; A63F 13/215; A63F 13/235; G06T 11/60; A63F 13/213; G06F 3/011; A63F 2300/8082; A63F 13/25

(57) ABSTRACT

Virtual reality systems described herein may translate a user's movement from a real space to a virtual environment. The system may include a plurality of sensors configured to capture user motion, such as one or more pressure sensors. The sensors may be arranged into configurable modular elements which may be combined to form a sensor array upon which the user may move. A computing device connected by at least one interface to the plurality of sensors may receive data from the sensors, interpret the data, and cause a corresponding motion in a virtual reality environment. The computing device may interpret the data further based on other information received about user movement, including information received from positional trackers, cameras, or the like. The corresponding motion made in the virtual reality environment may be based in part on a vector representative of the user's movement.

### CROSS REFERENCE TO RELATED APPLICATIONS

This application claims benefit to provisional Application No. 62/406,457, filed Oct. 11, 2016, herein incorporated by reference in its entirety, for all purposes.

### FIELD

Aspects described herein relate to human-computer interface devices. More specifically, aspects described herein relate to input devices usable to provide locomotion input to a computer system, e.g., for use with virtual reality, augmented reality, and/or mixed reality environments, or other applications or systems that may benefit from locomotion input.

### BACKGROUND

Virtual Reality (“VR”), Augmented Reality (“AR”), and Mixed Reality (“MR”) describe computer systems used to allow a user to view and interact with a virtual environment. Such virtual environments may comprise simulations of light, sound, touch, and movement, such that a user may navigate and manipulate the virtual environment as if it were real, or may augment the user's environment, e.g., using a system such as HOLOLENS™ products sold by Microsoft Corp. of Redmond, Wash. The degree of immersion in a virtual environment is often correlated with a computer system's ability to replicate, for example, the natural motions of the user. There is thus an ever-present need to improve ways in which user locomotion is translated into virtual environments.

Known input systems relating to locomotion include, for example, floor mat game controllers such as the Power Pad sold by Nintendo Co., Ltd. of Kyoto, Japan, and various dance pad controllers sold by Konami Corp. of Tokyo, Japan. Such a device is disclosed in U.S. Pat. No. 6,786,821 to Nobe et al. These floor mat game controllers are designed to emulate button presses on a video game controller using a user's feet and thereby ultimately fail to emulate natural locomotion.

Known systems further include treadmill devices that track the user's movement on the treadmill. Such a device is disclosed in U.S. Pat. No. 5,562,572 to Carmein. These treadmill devices are often mechanically complicated, and are thus encumbered by the inherent lag times and momentum problems associated with moving mechanical masses.

Other known systems include a concave base that the user steps into and walks in place, as gravity brings the user back into the center of the concave base. Such a device is disclosed in U.S. Pat. App. PCT/US2015/021614. This system is cumbersome, as the user has to wear a harness and special shoes in order to use the system, adding cost and complexity.

Yet another system uses a pressure-sensitive mat that the user walks around on. This system is disclosed in U.S. Pat. No. 7,520,836 to Couvillion et al. While this system reduces the complexity of other systems, the user only has a finite area to move around in the virtual environment.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects described herein provide a system which uses an array of sensors to determine the natural motion of a user and implement such motions in a virtual environment.

A sensor array may be configured with a plurality of sensors, such as pressure-sensitive sensors, which detect the motion of a user. The sensor array may be configured to transmit signals from the sensors to a computing device. A computing device may, based on these signals and, if available, other information from other additional sensors, determine a vector corresponding to both a magnitude and direction of a user's movement in real space. The computing device may translate this vector into the virtual environment such that, for example, the user's motion in real space is substantially replicated in the virtual environment.

The sensor array described herein may be comprised of one or more modular elements which each comprise one or more sensors. For example, the sensor array may substantially comprise an octagon comprising eight different modular elements connected together. Each modular element may contain one or more sensors to detect, for example, pressure, and may additionally include additional sensors and/or a microcontroller for sending signals from the sensors to the computing device. The modularity of the sensor array allows the array to be as large or as small as a user may desire.

The vector determined by the computing device may be based on not only signals from the sensor array, but from other information available to the computing device, thereby enhancing accuracy. For example, the positional tracking used in modern virtual reality headsets, such as the VIVE™ virtual reality headset sold by HTC Corporation of Taoyuan, Taiwan, may be used by the computing device to better process signals received from the sensor array.

The details of these and other features are set forth in the accompanying drawings and the description below. Other features and advantages will be apparent from the description and drawings, and from the claims.

### BRIEF DESCRIPTION OF THE DRAWINGS

These and other features, aspects, and advantages of the present disclosure will become better understood with regard to the following description, claims, and drawings. The present disclosure is illustrated by way of example, and not limited by, the accompanying drawings in which like numerals indicate similar elements.

FIG. 1 depicts an illustrative sensor array divided into a plurality of modular elements.

FIG. 2 depicts an illustrative sensor array shaped like an octagon and comprising 9 modular elements.

FIG. 3 depicts an illustrative sensor array shaped like a circle and utilizing a joint bottom layer and top layer.

FIG. 4 is a diagram of the layers used in the sensor array from FIG. 3.

FIG. 5 is a schematic of illustrative pressure sensors.

FIG. 6 depicts a flow chart illustrating steps which may be taken by a computing device.

FIG. 7 illustrates general hardware elements that can be used to implement any of the various computing devices discussed herein.

### DETAILED DESCRIPTION

In the following description of the various features, reference is made to the accompanying drawings, which form a part hereof, and in which is shown by way of illustration, various features of the disclosure that may be practiced. It is to be understood that other features or combinations of features may be utilized.

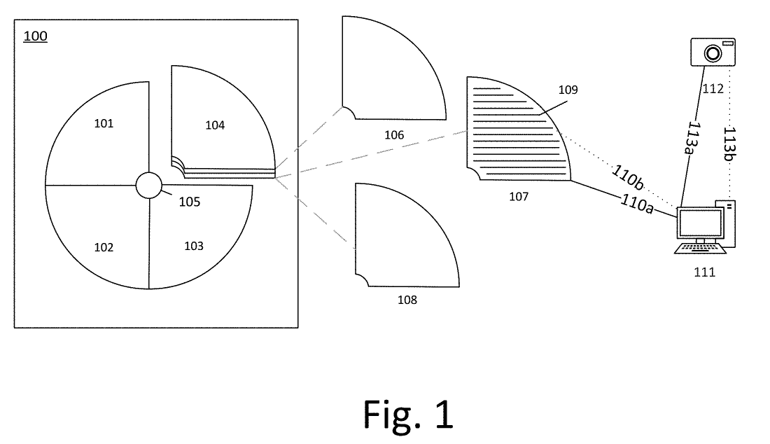

FIG. 1 depicts an illustrative sensor array 100 divided into modular elements 101-105. Sensor array 100 may be divided into any number of modular elements. As depicted in FIG. 1, for example, sensor array 100 has been divided into five modular elements 101-105. Sensor array 100 may be designed to be stepped on and may resemble a floor mat or pad.

Sensor array 100 may be any appropriate shape for capturing user locomotion. For example, sensor array 100 may substantially comprise a circle, oval, square, or octagon. Indeed, because sensor array 100 may be comprised of modular elements 101-105, further discussed below, sensor array 100 may be configured into a wide variety of shapes. Sensor array 100 may be shaped such that certain, more frequently used portions of sensor array 100 are larger than less commonly used portions of sensor array 100. For example, a portion of sensor array 100 corresponding to forward motion may be larger than a portion of sensor array 100 corresponding to backwards motion.

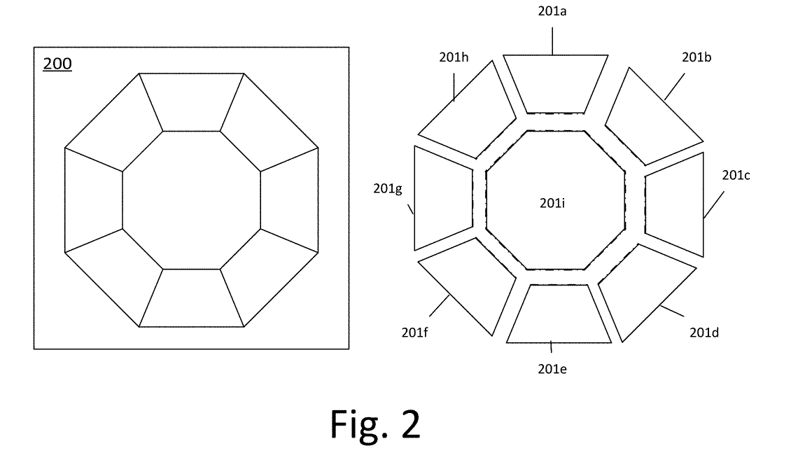

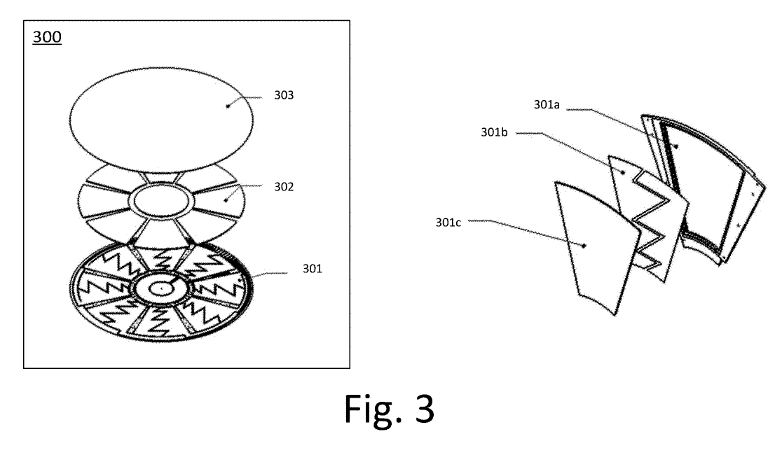

Sensor array 100 may have one or more modular elements 101-105. Like the sensor array 100, modular elements may be any shape. Modular elements may, for example, be square tiles similar to floor tiles to allow for a limitless number to be connected together, or may be one or more portions of a fixed shape, such as the circular shape depicted in FIG. 1. Modular elements 101-105 may contain one or more mechanisms which allow modular elements to be connected together. For instance, rather than four modular elements as depicted in FIG. 1, sensor array 100 may feature eight modular elements comprising portions of an octagon. Modular elements may feature a rail system which allow two or more modular elements 101-105 to be connected together to ultimately form a larger shape shape, such as the octagonal shape depicted in FIG. 2 and the circular shape depicted in FIG. 3. Such mechanisms may include one or more interfaces and one or more microcontrollers which enable communication between one or more modular elements 101-105.

Each modular element 101-105 may contain one or more layers. Each modular element may comprise a top layer 106, a sensor layer 107, and a bottom layer 108. The bottom layer 108 may be designed for impact resistance and/or cushioning, whereas the top layer 106 may be designed to protect sensor layer 107 from the user. These layers may be any material or combination of material. Material considerations for layers may be made based on a variety of considerations, including structural integrity, comfort, durability, cost, and cleanliness. For example, bottom layer 108 may be plastic and rubber, sensor layer 107 may be one or more sensors 109 and foam, and top layer 106 may be plastic. As another example, a more expensive modular element may be entirely built from metal and rubber.

Each modular element 101-105 may have more or fewer layers as necessary. For instance, some modular elements might not have a bottom layer 108. Each modular array may comprise a single layer 107 containing one or more sensors. Such a barebones modular array may be useful where, for example, a user wishes to place such sensors underneath a floor covering, such as underneath floor tiles or a rug.

The one or more sensors 109 may be any sensor(s) appropriate for detecting user locomotion and transmitting a signal based on the locomotion. The one or more sensors 109 may include one or more pressure-sensitive sensors, such as resistive type pressure sensors and/or load cells. The one or more sensors 109 may be configured to detect any information relating to user locomotion, such as pressure, weight, impact, or the like. The one or more sensors may be different types of sensors in any configuration such that, for example, a plurality of sensor types may be on the same modular element 101-105. Where more than one sensor of the one or more sensors 109 is in a modular element 101-105, the more than one sensor may be disposed in the modular element 101-104 in any appropriate manner that best detects user locomotion. For example, if modular element 104 contained a hundred pressure-sensitive sensors, the pressure-sensitive sensors may be arranged to substantially form a one hundred-element grid across sensor layer 107 to best capture user locomotion across the entirety of, e.g., modular element 104.

Sensors may substantially overlap such that redundancies may exist. For example, one or more sensors 109 may be configured such that pressure in an area of modular element 104 causes a plurality of the sensors to transmit signals. Such redundancies may be useful to increase the accuracy of the signal transmitted by the one or more sensors.

Modular elements 101-105 may contain additional hardware or circuitry to transmit signals from sensor(s) contained in the modular element. Each modular element may contain a microcontroller (not pictured) used to transmit signals from one or more sensors to another modular element or to computing device 111.

Modular elements 101-105 may also contain circuitry which enhances VR/AR/MR tracking, such as circuitry which facilitates positional tracking of a user. For example, the VIVE™ infrared lighthouses sold by HTC Corporation of Taoyuan, Taiwan currently use infrared light signals to allow a headset to track its position in real space. Infrared LEDs may be implemented into one or more modular elements 101-105 for similar purposes.

One or more modular elements 101-105 may be designated as a neutral zone such that the user may stand on it when movement in the virtual environment is not desired. In FIG. 1, modular element 105 may be designated a neutral zone because it is in the center of sensor array 100. The designation of one or more modular elements 101-105 does not mean that the particularly designated modular element is any different than other modular elements. For example, in FIG. 1, modular element 103 may be designated as a neutral zone. The designation of one or more neutral zones may be changed over time—for instance, a user may move to stand on modular element 101, but remain standing on modular element 101 such that modular element 101 is reclassified as a neutral zone.

Sensor array 100 may have one or more wired or wireless interfaces 110a-110b configured to transmit signals associated with the one or more sensors associated with modular elements 101-105 to computing device 111 or to other modular elements 101-105. Such one or more interfaces 110a-110b may be wired or wireless, and may comprise one or a plurality of interface types. For instance, FIG. 1 depicts both a wired interface 110a and wireless interface 110b ultimately connecting sensor layer 107 to computing device 111. Interfaces 110a-110b may be interrupted by one or more intermediary computing devices, such as a hub or switch. Interfaces 110a-110b may be a combination of interfaces: for instance, each modular element 101-104 may use a wired interface, such as copper wire, to connect one or more sensors to a microcontroller (not pictured), and the microcontroller may process and transmit the signals using a second format and over a second wireless interface to computing device 111. In this manner, the speed of a physical interface connection may be balanced with the convenience and reduced tripping hazard of a wireless interface.

As noted above, one or more modular elements 101-105 may receive signals from other modular elements 101-105. Modular element 105, for example, may receive signals over a first interface from modular elements 101-104 and transmit them, using the same or a second interface, to computing device 111. In this manner, only one modular element need be tasked with transmitting to computing device 111. These communications may also reduce the need for interfaces between sensor array 100 and computing device 111: if sensor array 100 were the size of an entire room with tens of modular elements, then intra-modular element communications would prevent the need for tens of wires running from each modular element to computing device 111.

As will be detailed further below, computing device 111 may be any computing device ultimately connected to sensor array 100 through one or more interfaces 110a-110b. Computing device 111 may be physically attached to sensor array 111 as well. For example, computing device 111 may be located underneath modular element 105. Computing device 111 may additionally or alternatively be, as explained in more detail below, a personal computer, laptop, video game console, or the like physically separated from sensor array 111.

Computing device 111 may be configured with one more additional sensors 112 relating to user motion. The one or more additional sensors 112 may include, for example, one or more motion trackers, such as the aforementioned VIVE™ infrared lighthouses sold by HTC Corp. of Taoyuan, Taiwan, the OCULUS™ sensor devices sold by Oculus VR of Irvine, Calif., or the KINECT™ motion sensing input device sold by Microsoft Corp. of Redmond, Wash. The additional sensors 112 may transmit signals to computing device 111 over one or more wireless or wired interfaces 113a-113b, which may be separate to or the same as the one or more interfaces 110a-110b. For example, computing device may receive signals from both sensor array 100 and the one or more additional sensors 112 over Bluetooth.

FIG. 2 depicts a sensor array 200 configured to be shaped like an octagon, comprising modular elements 201a-201i. As can be seen in FIG. 2, each modular element may be shaped such that, when assembled, the octagonal shape of sensor array 200 is formed. Because modular elements 201a-201h have the same shape and size, the particular ordering and arrangement of modular elements 201a-201h may be irrelevant, and each modular element of modular elements 201a-201h may be exchanged with another modular element. Modular elements 201a-201h and 201i feature mechanisms which allow the modular elements to be attached. As discussed above, such modular element attachment mechanisms may comprise, for example, a rail system, and may further comprise an interface which allows modular elements to communicate.

FIG. 3 depicts a sensor array 300 configured to be shaped like a circle and comprising a plurality of modular elements. In FIG. 3, structure 301 may be comprised of a bottom layer 301a, a sensor layer 301b, and a top layer 301c. Structure 301 may be beneath a cushioning layer 302 and a protective layer 303. Thus, while FIG. 3 depicts a bottom, sensor, and top layer like FIG. 1, FIG. 3 illustrates that sensor array 300 may have additional cushioning layer 302 and protective layer 303. As indicated by protective layer 303, a layer may be contiguous, rather than divided based into modular elements. The contiguous nature of protective layer 303 may allow the protective layer to be more easily cleaned and may reduce the risk of a user tripping on sensor array 300. The modular nature of cushioning layer 302 allows cushioning layer 302 to be modified on a per-modular element basis. For instance, a user may prefer thicker cushioning in the center portion of sensor array 300 but prefer thinner cushioning on one or more distal modular elements. The cushioning may be textured or otherwise modified to provide tactile feedback to the user.

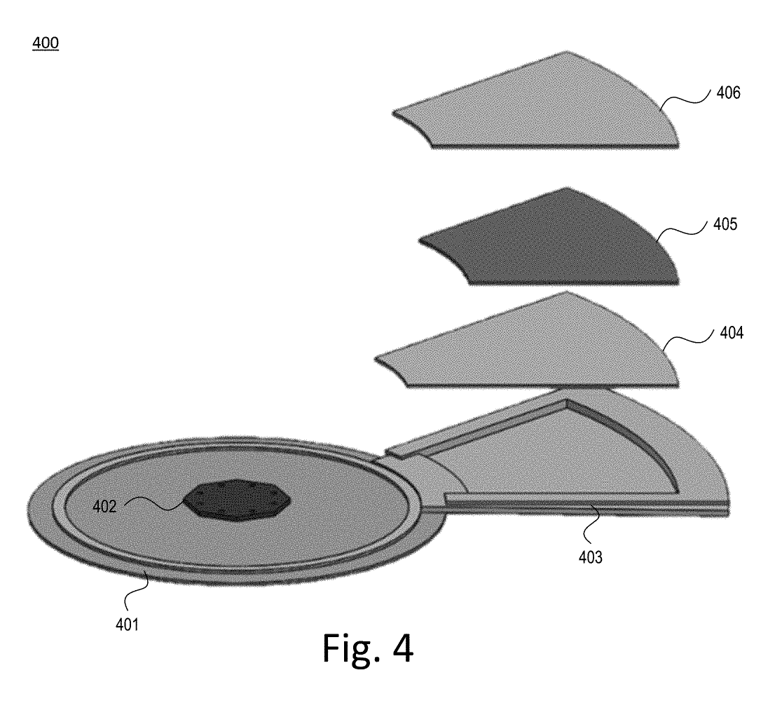

FIG. 4 depicts a cutout of sensor array 400. Modular element 401, the center of the circular sensor array 400, may contain a microcontroller or other computing device 402 configured to receive sensor information from other modular elements. Various interfaces (not pictured) may transmit sensor information from one or more modular elements to the microcontroller or other computing device 402 and ultimately to computing device 111. Support structure 403 may be a metal or other sturdy material configured to hold bottom layer 404, sensor layer 405, and top layer 406.

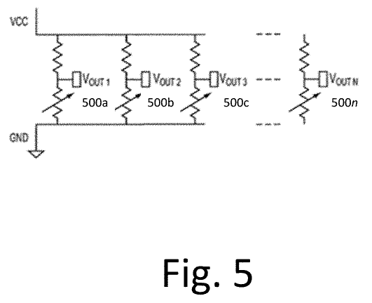

FIG. 5 is a schematic illustrating resistive pressure sensors which may be configured in any of the sensor arrays discussed herein. A voltage, V_{CC}, may be applied across n resistive pressure sensors, 500a-500n. Pressure applied to the resistive pressure sensors 500a-500n may change the resistance of at least a portion of the resistive pressure sensor, thereby changing a corresponding Vₒᵤₜ of the sensor. For instance, where V_{CC} is 5 V and the two resistors of resistive pressure sensor 500a have a baseline resistivity of 5 ohms each, then

$${V}_{out} = ( 5 V ) ( \frac{5 Ω}{5 Ω + 5 Ω} ) = 2.5 V .$$

But if pressure changes the resistivity of the second sensor to 10 ohms, then

$${V}_{out} = ( 5 V ) ( \frac{10 Ω}{5 Ω + 10 Ω} ) = 3.3 \overline{3} V .$$

This increase in voltage may be detected and associated with a change in pressure.

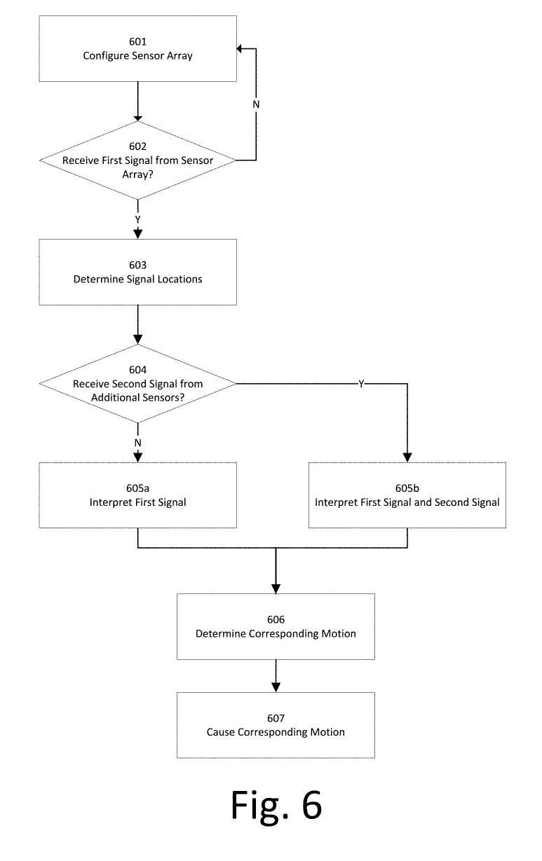

FIG. 6 depicts a flowchart illustrating steps which may be taken by computing device 111 or other suitable device.

In step 601, sensor array 100 is configured. Configuration may include establishing one or more wired or wireless interfaces 110a-110b. Sensor array 100 may, for example, be a Universal Serial Bus Human Interface Device (“USB HID”) (e.g., a USB HID compliant device) and use one or more device drivers to establish communications with computing device 111. The manner in which one or more wired or wireless interfaces 110a-110b may be established depends on the nature of the interface.

Configuration in step 601 may include determining one or more baseline measurements for the one or more sensors 109, such as a value of the sensor when the user is not moving. In this step, computing device 111 may determine a threshold sensitivity level associated with one or more sensors 109. If, for example, sensor array 100 comprises a plurality of pressure-sensitive sensors, the baseline measurements may allow the computing device 111 to determine readings to ignore from the sensor array 100. In this manner, if two sensors' baselines are different, computing device 111 may account for this difference in subsequent calculations. For instance, computing device 111 may detect that, when a user is not moving, a sensor erroneously reports motion, and thus computing device 111 may ignore or reduce its consideration of signals from that sensor. Such a baseline may change over time. For example, the layers of one or more modular elements 101-105 may wear down with use such that a sensor reads more pressure at baseline after thirty minutes of use than it did when initially configured. Computing device 111 may thus reset the baseline measurements to account for such changes.

In configuration step 601, one or more portions of sensor array 100 may be disabled or ignored based on, for example, whether all or part of sensor array 100 is broken or not needed for a particular program executing on computing device 111. For example, if sensor array 100 covers the entire floor of a large room but a program executing on computing device 100 does not require that a user move around the entire room, a portion of sensor array 100 may be disabled to maximize the computational efficiency of computing device 111, to conserve power, and/or to reduce confusion by a user inadvertently stepping on an unused sensor. Computing device 111 may instruct a microcontroller in sensor array 100 to cease transmission of signals associated with one or more sensors on this basis.

In configuration step 601, modular elements 101-105 may be classified or ranked, including classifying one or more modular elements as a neutral zone. A neutral zone may be classified where a portion of sensor array 100 is associated with a lack of motion, that is, standing. Computing device 111 may instruct microcontrollers in sensor array 100 to cease transmission of signals associated with sensors in a neutral zone. Additionally or alternatively, computing device 111 may simply ignore and/or discard signals received that are associated with sensors in a neutral zone. The neutral zone may change over time based on, for example, the nature of a program executing on computing device 111 such that this configuration step may be repeated by computing device 111 as needed.

Configuration step 601 may further entail determining the locations of one or more sensors. As will be described in more detail below, the location of the one or more sensors may have different implications based on, for example, the orientation of the user. Sensors may be identified based on their location within a modular element or based on their location in sensor array 100. For instance, modular elements 101-105 may be configured using microcontrollers to communicate and determine the way in which they have been attached to ultimately determine the locational relationship between sensors. Computing device 111 may additionally or alternatively require a user to implement one or more configuration steps to identify positions on sensor array 100. Computing device 111 may, for example, prompt a user to step on portions of sensor array 100 corresponding to cardinal directions and associate sensors actuated during such steps with the cardinal directions.

In step 602, one or more signals are received from sensor array 100. These signals may be on one or more interfaces. For instance, the one or more signals received from sensor array 100 may comprise quantized values of sensor readouts transmitted over a wireless connection, such as Bluetooth.

The one or more signals transmitted by sensor array 100 and received in step 602 may be formatted in a variety of ways. Sensor array 100 may use one or more microcontrollers to process and transmit digitized forms of analog signals transmitted by sensors in sensor array 100. Sensor array 100 may additionally or alternatively multiplex signals received from the one or more sensors and transmit the multiplexed signals as a single signal to the computing device 111. Because input lag is undesirable, minimal processing may be preferable before signals are received by computing device 111. As such, the format of the signals received in step 602 may be very basic and require processing by computing device 111.

Receipt of signals in step 602 may be responsive to a request by computing device 111. Some standards, including the USB HID specification, entail a process whereby computing device 111 polls sensor array 100 at a frequency, such as 250 Hz. This process advantageously allows computing device 111 to vary the polling frequency based on, for example, the desired fidelity of information from sensor array 100.

Processing of the signal may be required upon receipt to decrypt or reduce errors in the signal. For example, if the signal received in step 602 contains a number of errors, any number of known algorithms may be used to correct such errors. If the signal received from sensor array 100 is multiplexed, computing device 111 may demultiplex the signal.

In step 603, computing device 111 may determine the locations of the signals received with respect to sensor array 100. The signal retrieved in step 602 may contain sufficient information to allow computing device 111 to determine the location of each sensor as well as one or more readings associated with the sensor. Such locational information may be based on the locations determined in step 601.

In step 604, computing device 111 may receive one or more second signals from one or more additional sensors 112 over one or more interfaces 113a-113b. Sensors may come from a variety of sources, including one or more positional trackers, cameras, microphones, accelerometers, gyroscopes, or the like. The particular manner in which a signal is received by computing device 111 will differ based on the additional sensor 112 in question. For example, a positional tracker may be connected to computing device 111 over USB, but an accelerometer may be included in a wireless video game controller. The second signals may be processed by a driver or an API executing on computing device 111. For instance, signals received by computing device 111 from sensor array 100 may come via a first API executing on a video game engine, whereas signals from a microphone additional sensor 112 may be received by computing device 111 using a second API.

In step 605a, if one or more second signals are not received by computing device 111, then computing device 111 interprets the one or more signals received from sensor array 100. In step 605b, if one or more second signals are received by computing device 111, then computing device 111 interprets the both the one or more signals received from sensor array 100 and the second signals. Interpretation of either or both signals may be based on any of the considerations discussed below.

Interpretation of signals received from sensor array 100 may be based on one or more values derived from the signals. Computing device 111 may process received signals to derive one or more values, such as a fixed reading, a rate of change, or the like. A sensor of the sensor array 100 may provide a range of values corresponding to, for example, a range of pressures on a pressure sensor. These values may be used to interpret user motion by, for example, associating certain values with walking and certain values with running. Such values may depend on the type of sensor in sensor array 100. For instance, a sensor of sensor array 100 may be configured to transmit signals indicating weight, but not pressure.

Interpretation of signals received from sensor array 100 may comprise determining a vector associated with signals received from sensor array 100. A large step towards the top of sensor array 100 may generate a different vector than, for example, a small step towards the bottom of sensor array 100.

Interpretation of signals received from sensor array 100 may comprise determining a direction in which a user faces. A user may, for instance, rotate their body 180 degrees and step forward. In this case, a signal that would formerly have represented a backwards step would represent a forwards step. The direction in which the user faces may be determined by current or historical signals received by sensor array 100 or the one or more second signals received by additional sensors 112.

Interpretation of signals received from sensor array 100 may comprise associating the direction in which the user faces and the vector associated with sensor array 100. A large step towards the top of sensor array 100, for example, may travel in different directions (and therefore involve different sensors on sensor array 100) based upon the direction in which the user faces. For example, if the user is facing towards the top of the sensor array, the step may indicate forward travel, whereas if the user is facing away from the top of the sensor array, the step may indicate backwards travel. Computing device 111 may determine an offset angle based on a comparison of the direction which the user is facing and the vector associated with user motion. This association may be used by computing device 111 to avoid forcing the user to re-orient their physical orientation with their virtual orientation.

The association of the direction in which the user faces and the vector associated with sensor array 100 may comprise determination of a second vector. An example of such calculations is provided in the following paragraphs.

For this example, let the sensor array 100 be a circle which is divided into n slices, where n is a multiple of 4. Let q be the number of modular arrays per quadrant of the sensor array 100, such that

$$= \frac{n}{4} .$$

Let θ be me central angle (in degrees) of the arc of each slice n such that

$$= \frac{360}{n} .$$

Let i be the ordering of each slice n within each quadrant where, counting in a clockwise fashion i ranges from 0, to i−1. Let r be the vector in a single slice n, where

$${r}_{x}^{2} + {r}_{y}^{2} = {r}^{2} , {r}_{x} = r sin ( \frac{θ}{2} + θ i ) , and {r}_{y} = r cos ( \frac{θ}{2} + θ i ) .$$

Then, let R be the vector of an entire quadrant composed of q slices:

$${R}_{x}^{2} + {R}_{y}^{2} = {R}^{2} , {R}_{x} = {\sum }_{i = 0}^{q - 1} {r}_{i} sin ( \frac{θ}{2} + θ i ) , and {R}_{y} = {\sum }_{i = 0}^{q - 1} {r}_{i} cos ( \frac{θ}{2} + θ i ) .$$

Since the magnitude of r is always positive, a sign must be placed on each vector R according to which quadrant it represents. Let the x-components of the first and second quadrants be positive, the x-components of the third and fourth quadrants be negative, the y-components of the first and fourth quadrants be positive, and the y-components of the second and third quadrants be negative. Finally, let the vector V be the summation of the quadrant vectors R such that Vₓ²+V_{y}²=V², Vₓ=Rₓ₁+Rₓ₂−Rₓ₃−Rₓ₄, and V_{y}=R_{y1}+R_{y2}−R_{y3}−R_{y4}. The vector V is the absolute directional vector generated by the absolute vector calculation algorithm.

The rotation of the user is presented through many VR, AR, and MR systems' API as a quaternion. The resultant vector representing the user's motion is a multiplication of the VR system's rotation of the user and the absolute directional vector. Let the quaternion of the VR System's rotation be Q, and the absolute vector be V. The velocity of vector of the user in a VR, AR, or MR virtual environment (Vᵤₛₑᵣ) is simply the cross product of the quaternion Q and the absolute vector V: Vᵤₛₑᵣ=Q×V

The rotation angle and quadrant calculation will generate an angle α which represents the offset of the absolute directional vector from the x or y axis. The angle α will enable the pad to apply a rotation to the absolute directional vector to generate a relative directional vector. The calculation of angle α is dependent on the magnitude of the x component of the absolute directional vector, the magnitude of the y component of the absolute directional vector, and the quadrant in which the absolute directional vector lies in, as follows:

Let the absolute directional vector components Vₓ, V_{y}, and p represent the x component, y component, and quadrant of the absolute directional vector. Let α represent the angle in which the absolute directional vector is offset from the nearest axis in the counter clockwise direction, such that: in the first quadrant, the x and y components are positive, and

$$α = {tan}^{- 1} \frac{\vert {V}_{x} \vert}{\vert {V}_{y} \vert} ;$$

in the third quadrant, the x and y components are negative, and

$$α = {tan}^{- 1} \frac{\vert {V}_{x} \vert}{\vert {V}_{y} \vert} ;$$

in the second quadrant, the x component is positive, the y component is negative, and

$$α = {tan}^{- 1} \frac{\vert {V}_{y} \vert}{\vert {V}_{x} \vert} ;$$

and in the third quadrant, the x component is negative, the y component is positive, and

$$α = {tan}^{- 1} \frac{\vert {V}_{y} \vert}{\vert {V}_{x} \vert} .$$

Let the rotation quadrant t equal the current quadrant of the absolute directional vector p such that t=p.

The application of rotation angle and quadrant offset algorithm uses the current quadrant of the absolute directional vector p, the offset quadrant t, and the rotation angle α to rotate the absolute directional vector p by α, and by quadrant t to create a new relative direction vector p′, as follows:

Let the absolute directional vector components Vₓ, V_{y}, and p represent the x component, y component, and quadrant of the absolute directional vector. Then, apply the rotation angle α, let p′ₓ=pₓ cos α−p_{y} sin α, and let p′_{y}=p_{y} cos α+pₓ sin α. Then, to apply the offset quadrant the following logic will rotate the offset vectors to the appropriate quadrant:

TABLE 1
Offset Vector Logic

| Offset Quadrant t | Pₓ′ | P_{y}′ |
|---|---|---|
| t = 1 | Do nothing | Do nothing |
| t = 2 | pₓ′ = −p_{y}′ | p_{y}′ = pₓ′ |
| t = 3 | pₓ′ = −pₓ′ | p_{y}′ = −p_{y}′ |
| t = 4 | pₓ′ = −p_{y}′ | p_{y}′ = −pₓ′ |

Discussion will now return to various methods of interpreting signals in steps 605a-605b.

Signals received by computing device 111 from sensor array 100 and/or signals from the one or more additional sensors 112 may be consistent or may conflict. For instance, signals received from sensor array 100 may indicate that a user desires to step forward, whereas signals received from the one or more additional sensors 112 may indicate that a user remains still. Computing device 111 may take any appropriate steps, including the considerations detailed below, to interpret signals in view of such conflict. For example, algorithms such as a Kalman filter may be used to resolve such conflicts.

Interpretation of signals received from sensor array 100 may depend on one or more classifications associated with either or both modular elements 101-105 or the one or more sensors 109. For instance, modular element 105 may be classified as a neutral zone such that sensor information from that modular element is interpreted as a desire to not move (e.g. standing or sitting). Such a classification may be analogous to the dead zone on an analog control stick, such as those found on video game controllers. Portions of modular elements 101-105 may be classified in other ways. For instance, the proximal portions of modular elements 101-105 may be associated with slow motion, whereas the distal portions of modular elements 101-105 may be associated with fast motion.

Interpretation of signals from sensor array 100 may further be based on a history of previous signals received from sensor array 100. For instance, a user playing an exciting action game may regularly fail to return to a classified neutral zone on one or more modular elements 101-105. In that case, computing device 111 may subsequently determine that stepping near, but not on, the classified neutral zone is still indicative of a lack of motion. As another example, a user may rest their foot in one or more areas of sensor array 100 but no longer wish to travel in the virtual environment.

Interpretation of signals from sensor array 100 may further be based on one or more physical limitations associated with a user. Computing device 111 may use information associated with the user, such as the user's height, athletic ability, or previous movements, to interpret motion by the user. Computing device 111 may further interpret signals from sensor array 100 in a manner to avoid or mitigate nausea.

Interpretation of signals from sensor array 100 may further be based on one or more programs executing on computing device 111. If, for example, a user were playing a video game wherein the user was facing a virtual wall, computing device 111 may interpret signals received from sensor array 100 based on an assumption that the user does not desire to walk into the wall.

Interpretation of signals from sensor array 100 may further be based on one or more algorithms associated with the signals. Computing device 111 may apply one or more weights to received signals or conflicting interpretations. Computing device may also use one or more machine learning algorithms to best determine user motion.

Interpretation of signals from sensor array 100 may further be based on one or more user preferences. A user may provide preferences to computing device 111 indicating that certain motions are to be associated with certain actions in the virtual environment. A user of sensor array 100 may, for example, prefer that all steps on a certain modular element 101-105 be interpreted as running, rather than walking.

In step 606, based on the interpretation of the one or more signals from sensor array 100 and, if applicable, the one or more signals received from additional sensors 112, computing device 111 may determine a corresponding motion in the virtual environment. The corresponding motion and the interpreted signals in steps 605a-605b may be the same or different. For example, a user playing a video game may attempt to move forwards, but the video game might not permit forwards movement due to, for example, a virtual wall. In such an example, the computing device 111 may determine that a second motion, such as a bouncing action off the virtual wall, may be appropriate. The corresponding motion may be no motion at all. One or more rules or algorithms, such as a Kalman filter, may be used to resolve such conflicts.

In step 607, computing device 111 causes the corresponding motion in the virtual environment. As noted above, the corresponding motion may be different than the interpreted motion and, in some instances, may be no motion at all. Because the computing device 111 may be operating an API to manage signals received from sensor array 100, the same program interpreting signals from sensor array 100 need not be the same program presenting the virtual environment to the user. For instance, the actions performed by computing device 111 in steps 601-606 may be performed by a driver executing on computing device 111 which ultimately transmits information to a second program, such as a video game, exercising on computing device 111.

In step 607, causing motion may comprise sending information relating to the corresponding motion to a second computing device, program executing on the computing device 111, or the like. Computing device 111 may transmit, to another program or second computing device, data indicating a vector associated with the corresponding motion in the virtual environment determined in step 606. The second computing device or other program may further process the received vector. As such, computing device 111 need only ultimately cause motion in the virtual environment through another program, computer, or the like.

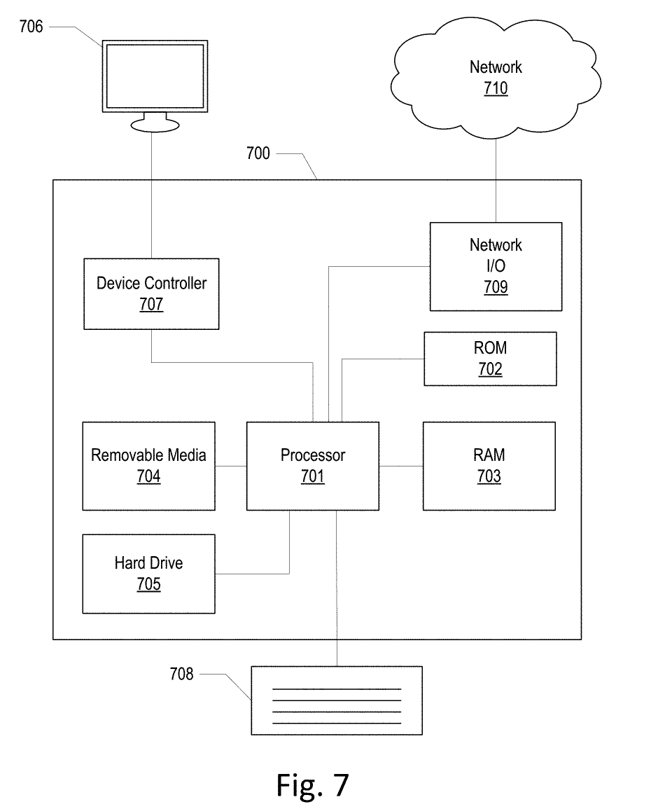

FIG. 7 illustrates some hardware elements that can be used to implement any of the various computing devices discussed herein. The computing device 700 may include one or more processors 701, which may execute instructions of a computer program to perform any of the features described herein. The instructions may be stored in any type of computer-readable medium or memory, to configure the operation of the processor 701. For example, instructions may be stored in a read-only memory (“ROM”) 702, random access memory (“RAM”) 703, removable media 704, such as a Universal Serial Bus (“USB”) drive, compact disk (“CD”) or digital versatile disk (“DVD”), floppy disk drive, or any other desired storage medium. Instructions may also be stored in an attached (or internal) hard drive 705. The computing device 700 may include one or more output devices, such as a display 706 (e.g., an external television), and may include one or more output device controllers 707, such as a video processor. There may also be one or more user input devices 708, such as a remote control, keyboard, mouse, touch screen, microphone, camera input for user gestures, etc. The computing device 700 may also include one or more network interfaces, such as a network input/output (I/O) circuit 709 (e.g., a network card) to communicate with an external network 710. The network input/output circuit 709 may be a wired interface, wireless interface, or a combination of the two. In some embodiments, the network input/output circuit 709 may include a modem (e.g., a cable modem), and the external network 710 may include a communications link, an external network, an in-home network, a provider's wireless, coaxial, fiber, or hybrid fiber/coaxial distribution system (e.g., a DOCSIS network), or any other desired network.

FIG. 7 provides an example of a hardware configuration, although the illustrated components may be wholly or partially implemented as software as well. Modifications may be made to add, remove, combine, divide, etc. components of the computing device 700 as desired. Additionally, the components illustrated may be implemented using basic computing devices and components, and the same components (e.g., processor 701, ROM storage 702, display 706, etc.) may be used to implement any of the other computing devices and components described herein. For example, the various components herein may be implemented using computing devices having components such as a processor executing computer-executable instructions stored on a computer-readable medium, as illustrated in FIG. 7. Some or all of the entities described herein may be software based, and may co-exist in a common physical platform (e.g., a requesting entity can be a separate software process and program from a dependent entity, both of which may be executed as software on a common computing device).

While illustrative reference has been made in various places to virtual reality and virtual environments, the teachings herein also apply to augmented reality and mixed reality environments. References to virtual reality should not be viewed as excluding augmented and/or mixed reality unless one is explicitly stated to the exclusion of the other(s).

One or more aspects of the disclosure may be embodied in a computer-usable media and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (“FPGA”), and the like. Particular data structures may be used to more effectively implement one or more aspects of the disclosure, and such data structures are contemplated within the scope of computer executable instructions and computer-usable data described herein.

Aspects of the disclosure have been described in terms of examples. While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the features of the aforementioned examples may be utilized alone or in combination or sub-combination with elements of the other examples. For example, any of the above described systems and methods or parts thereof may be combined with the other methods and systems or parts thereof described above. For example, the steps shown in the figures may be performed in other than the recited order, and one or more steps shown may be optional in accordance with aspects of the disclosure. It will also be appreciated and understood that modifications may be made without departing from the true spirit and scope of the present disclosure. The description is thus to be regarded as illustrative instead of restrictive on the present disclosure.

1. A method comprising:
receiving, by a sensor array comprising a plurality of sensors, first data corresponding to input of a user, wherein the first data is representative of pressure detected by the sensory array;
determining, based on the first data, a vector comprising a direction of motion and a magnitude of motion; and
causing movement in a virtual environment corresponding to the vector.

2. The method of claim 1, wherein the virtual environment is associated with a virtual reality, augmented reality, or mixed reality program executing on a computing device.

3. The method of claim 1, further comprising:
receiving, from an additional sensor different from the plurality of sensors, second data corresponding to the motion of the user,
wherein determining the vector is further based on the second data.

4. The method of claim 3, wherein the additional sensor is one of: a positional tracking device, a camera, a microphone, or an accelerometer.

5. The method of claim 3, wherein determining the vector is further based on a comparison of the first data and the second data.

6. The method of claim 1, further comprising:
determining, based on the first data, an orientation of the user,
wherein determining the vector is further based on the orientation of the user.

7. The method of claim 1, wherein the sensor array comprises a plurality of modular elements, and wherein each modular element comprises at least one sensor of the plurality of sensors.

8. The method of claim 7, wherein each modular element of the plurality of modular elements attaches to at least one other modular element to substantially form the sensor array.

9. The method of claim 1, further comprising:
determining a neutral zone associated with at least a portion of the sensor array, wherein the neutral zone comprises a region of the sensor array associated with the user standing, and wherein causing movement in the virtual environment is based on the neutral zone.

10. A sensor array comprising:
a plurality of modular elements, each containing at least one sensor configured to detect input of a user by stepping on a corresponding modular element, wherein each modular element is configured to attach to at least one other modular element, and wherein each modular element is further configured to communicate sensor information with at least one other modular element; and
at least one interface configured to transmit, to a first computing device, information associated with the input of the user, wherein the first computing device is configured to cause movement in a virtual environment corresponding to the information associated with the input of the user.

11. The sensor array of claim 10, wherein the plurality of modular elements, when attached together, form an octagon.

12. The sensor array of claim 10, wherein the plurality of modular elements comprise tiles arrangeable in a plurality of configurations on a floor.

13. The sensor array of claim 10, wherein each modular element is comprised of a plurality of layers, and wherein at least one sensor is located within one of the plurality of layers.

14. The sensor array of claim 10, further comprising:
a second computing device, configured to:
receive, from each sensor of the plurality of modular elements, sensor information;
multiplex the received sensor information; and
transmit, to the first computing device, the multiplexed sensor information.

15. The sensor array of claim 10, wherein at least one modular element of the plurality of modular elements further comprises a positional tracking device.

16. A system comprising:
a sensor array comprising a plurality of modular elements, wherein each modular element contains at least one sensor configured to detect input of a user by stepping on a corresponding modular element, wherein each modular element is configured to attach to at least one other modular element, and wherein each modular element is further configured to communicate sensor information with at least one other modular element; and
a computing device configured to:
receive, from the sensor array, first data corresponding to the input of the user;
determine, based on the first data, a vector comprising a direction of motion and a magnitude of motion; and
cause movement in a virtual environment corresponding to the vector.

17. The system of claim 16, further comprising:
an additional sensor separate from the sensor array,
wherein determining the vector is further based on second data received from the additional sensor.

18. The system of claim 17, wherein the additional sensor is one of: a positional tracking device, a camera, a microphone, or an accelerometer.

19. The system of claim 16, wherein the computing device is further configured to:
determine a neutral zone associated with at least a portion of the sensor array, wherein the neutral zone comprises a region of the sensor array associated with the user standing, and wherein causing movement in the virtual environment is based on the neutral zone.

20. The system of claim 16, wherein the virtual environment is associated with a virtual reality, augmented reality, or mixed reality program executing on the computing device.
